(19) United States
(12) Patent Application Publication
(10) Pub. No.: US 2026/0142196 A1
(43) Pub. Date: May 21, 2026

(54) RAPID MANUFACTURING OF ULTRA-THIN SOLID OXIDE CELLS FOR FUEL CELLS AND ELECTROLYZERS

(71) Applicant: UNIVERSITY OF CONNECTICUT, Farmington, CT (US)

(72) Inventors: Xiao-Dong Zhou, Columbia, CT (US); Nengneng Xu, Vernon, CT (US); Yudong Wang, Willimantic, CT (US); Zizhou He, Willimantic, CT (US)

(21) Appl. No.: 19/397,296

(22) Filed: Nov. 21, 2025

Related U.S. Application Data
(60) Provisional application No. 63/723,332, filed on Nov. 21, 2024.

(51) Int. Cl. H01M 4/90; C25B 1/04; H01M 4/86; H01M 8/12; H01M 8/1253; H01M 8/126

(52) U.S. Cl. CPC H01M 4/9033; C25B 1/04; H01M 4/8621; H01M 8/1253; H01M 8/126; H01M 2008/1293

(57) ABSTRACT

The present teachings describe electrolytes and electrodes (anodes and cathodes), usually as a layered system, for use in solid oxide cells such as solid oxide fuel cells and electrolyzers. The present teachings also describe methods of using the electrolytes and electrodes and solid oxide cells as well as methods of making the electrolytes, electrodes, and SOCs.

### CROSS REFERENCE TO RELATED APPLICATION

This application claims priority to U.S. Patent Application No. 63/723,332, filed Nov. 21, 2024, the contents of which are incorporated by reference in their entirety herein.

### STATEMENT REGARDING FEDERALLY SPONSORED RESEARCH

This invention was made with government support under DE-AR0001774 awarded by the U.S. Department of Energy. The government has certain rights in the invention.

### BACKGROUND OF THE INVENTION

### 1. Field of the Invention

The invention disclosed herein relates to electrolytes and electrodes, for example, anodes and cathodes, and in particular, to electrolytes and electrodes for solid oxide cells.

### 2. Description of the Related Art

In the current state-of-the-art fabrication of electrodes for solid oxide cells (SOCs), the predominant method remains the preparation of electrode or cell components via a slurry followed by extended ball-milling for greater than 24 hours (h). This approach, commonly used in the manufacture of solid oxide fuel cells (SOFCs), begins with mixing ceramic powders (e.g., NiO-YSZ for the anode, YSZ for the electrolyte, and LSC/LSCF for the cathode) and binder materials in a solvent to form a slurry. The slurry is ball-milled to achieve homogenous particle dispersion and then cast into “green” tapes (via tape-casting), which are subsequently laminated, cut, co-sintered and integrated to form the full cell architecture. As described in previous work, tape casting, lamination and co-sintering have been used to form gas-tight YSZ membranes on porous anode supports and then deposition of cathode layers.

Because of the long milling times, multiple processing steps (casting, lamination, drying, sintering), and the co-sintering of multi-layer green tapes, the overall yield rate in production remains relatively low. Errors in tape quality, lamination defects, warping during sintering, delamination or cracking all contribute to scrap, and the long process times reduce throughput.

More recently, alternative electrode fabrication strategies have begun to emerge to address these limitations. For example, infiltration methods, where nano-scale catalytic particles are delivered into a pre-sintered porous electrode scaffold, have been shown to reduce heat-treatment steps and allow greater control of microstructure and catalyst loading. Also, rapid fabrication routes such as “extreme heat treatment” (EHT) have been applied to symmetrical solid oxide cells to fabricate porous electrodes in seconds rather than tens of hours, significantly shortening the manufacturing time. Meanwhile, advanced architectures such as nanofiber-based electrode layers have been developed, increasing surface area, lowering sintering temperature, and improving adhesion to the electrolyte. These emerging methods suggest pathways to reduce processing time, simplify the fabrication sequence, and improve yield, but as yet the slurry-based tape-casting/lamination method remains dominant in commercial and research settings.

What the industry needs is improved electrolyte and electrode technology, including the composition of the electrolytes and electrodes, methods of using and methods of making, to result in improved solid oxide cells.

### SUMMARY

In one aspect, the present teachings provide electrolytes and electrodes, i.e., an anode and a cathode. Accordingly, the present teachings provide, in part, an electrolyte layer such as a thin or an ultra-thin electrolyte layer. The electrolyte layer includes a sintered electrolyte particulate material with substantially unchanged electrolyte particulates based on particle size and morphology prior to sintering. The electrolyte particulates can include one or more metal oxides selected from gadolinium oxide, cerium oxide, yttrium oxide, scandium oxide, zirconium oxide, hafnium oxide, niobium oxide, tantalum oxide, calcium oxide, strontium oxide, barium oxide, praseodymium oxide, neodymium oxide, samarium oxide, europium oxide, terbium oxide, dysprosium oxide, holmium oxide, erbium oxide, thulium oxide, and ytterbium oxide. The electrolyte layer can have a thickness between about 1 micrometers (μm) and about 50 μm. An ultra-thin electrolyte layer can have a thickness between about 1 μm and about 25 μm, or about 10 μm, or about 5 μm, or less. In certain embodiments, the ultra-thin electrolyte layer is an acoustic energy slurry-formed electrolyte layer.

In various embodiments, an electrolyte layer is provided including a sintered ceramic material, where the electrolyte layer establishes a mean grain size between 1 micrometer and 3 micrometers, and a ceramic powder used to form the electrolyte layer establishes a mean particle size between 80 nanometers and 250 nanometers. The ratio of the mean grain size to the mean particle size can remain between 4 and 37.5. The electrolyte layer can have a thickness between 0.1 micrometers and 25 micrometers, for example, between 1 micrometers and 25 micrometers. In certain embodiments, the electrolyte layer establishes a porosity less than about 0.5 percent by volume. The sintered ceramic material can include a solid solution that includes at least one oxide selected from zirconium oxide, yttrium oxide, scandium oxide, hafnium oxide, cerium oxide, and gadolinium oxide. The electrolyte layer can include yttria-stabilized zirconia or a ceria-based ceramic selected from gadolinium-doped ceria and samarium-doped ceria.

The electrolyte layer can lack an interconnected pore network across its thickness. The electrolyte layer can display a grain morphology consistent with an angular or equiaxed particulate morphology of the ceramic powder. The electrolyte layer can provide an ohmic area-specific resistance below 0.03 ohm-centimeter squared at a temperature range of 700 oC to 800 oC. In certain embodiments, the electrolyte layer is part of a three-layer structure including an anode layer and an anode support layer positioned on one side of the electrolyte layer, with the anode layer adjacent to the electrolyte and the anode support on the opposite side of the anode. The three-layer structure can enable continuous particulate contact across the interface between the anode layer and the anode support layer. The three layer structure can lack a lamination boundary between the anode layer and the anode support layer.

In various embodiments, a solid oxide cell is provided including an electrolyte layer as described herein, an anode layer disposed on a first surface of the electrolyte layer, and a cathode layer disposed on a second surface of the electrolyte layer, usually opposite of the anode layer. The solid oxide cell can further include an anode support layer disposed on the anode layer. The anode layer can include nickel oxide and a ceramic oxide that matches the composition of the electrolyte layer. The cathode layer can include a perovskite-type oxide selected from lanthanum strontium manganite, lanthanum strontium cobalt ferrite, and barium strontium cobalt ferrite. The solid oxide cell can further include a barrier layer disposed between the electrolyte layer and the cathode layer. The electrolyte layer can establish a mean grain size within ±30 percent of the mean particle size of the ceramic powder used to form the electrolyte layer. The electrolyte layer can exhibit a grain morphology that matches a particulate morphology of the ceramic powder.

An apparatus is provided comprising a plurality of solid oxide cells as described above and an electrical circuit configured to receive electrical energy from the plurality of solid oxide cells or supply electrical energy to the plurality of solid oxide cells. The apparatus can operate as a reversible energy-storage system that supplies electrical energy during fuel-cell operation and stores electrical energy in chemical form during electrolyzer operation.

The present teachings also provide a solid oxide cell (SOC). The SOC includes one or more of an ultra-thin electrolyte layer, an anode layer, and a cathode layer, and other optional layers such an anode support layer and/or a barrier layer, all as described herein. The present teachings also include an article of manufacture. The articles of manufacture include a solid oxide cell as described herein. The articles of manufacture can be selected from a battery, a fuel cell, and an electrolyzer.

In another aspect, the present teachings provide methods of using the SOCs and articles of manufacture. The methods generally include flowing an electrical current through the SOC.

In another aspect, the present teachings provide methods of making the electrolyte layer, and individual electrode layers, and SOCs, all as described herein. The method of fabricating a SOC can include mixing a dispersant in a solvent using acoustic energy; adding an electrolyte powder, a plasticizer, and a binder to the mixture including the mixed dispersant in the solvent, and mixing using acoustic energy to provide a slurry; de-gassing the slurry, optionally with acoustic energy; and casting the de-gassed slurry to create an electrolyte layer. Subsequently, the anode layer and anode support layer, if present, can be added to one side of the electrolyte. This three-layered structure can be sintered. The opposite side of the electrolyte can be optionally coated with a barrier layer, and then a cathode layer, to complete the SOC.

These and other features will be more clearly understood from the following drawings, detailed description and examples as well as the appended claims.

### BRIEF DESCRIPTION OF THE DRAWINGS

The features and advantages of the invention are apparent from the following description taken in conjunction with the accompanying drawings.

FIG. 1A is a schematic flow chart diagram of an embodiment of the present teachings illustrating the fabrication of the different tape-cast slurry-made electrolyte and electrode layers to ultimately form an SOC.

FIG. 1B is a schematic diagram of an embodiment of an SOC, showing the different layers and their position.

FIGS. 2A and 2B, collectively referred to herein as FIG. 2, are scanning electron microscope (SEM) images at 1000× and 3000× magnification, respectively, of an SOC cross-section made in accordance with the present teachings.

FIGS. 3A and 3B are SEM images of the typical cell made with the accelerated SOFC cell fabrication technology as described herein.

FIGS. 4-6 are graphs of fuel cell performance evaluation at temperatures between 600 oC to 800 oC of an embodiment of a solid oxide fuel cell of the present teachings.

FIG. 7 is a graph of fuel cell stability evaluation at a temperature of 750 oC, where the cathode air flow was 600 sccm, and the anode hydrogen flow was 300 sccm. The degradation rate of the fuel cell as measured by its volage was less than 0.058 mV/h over 253 hours.

FIG. 8 is a graph of a fuel cell thermal stability evaluation between the temperatures of 400 oC to 750oC, with a 1 A/cm2 thermal cycle and cathode air flow of 500 sccm, and anode hydrogen flow of 300 sccm.

### DETAILED DESCRIPTION OF THE INVENTION

The present teachings provide electrolytes and electrodes and components thereof. For example, the present teachings provide, in part, an electrolyte that includes a sintered electrolyte particulate material, wherein the sintered electrolyte particulate material includes substantially unchanged electrolyte particulates based on particle size and morphology prior to sintering. The electrolyte can be formed into an electrolyte layer, such as a thin electrolyte layer or an ultra-thin electrolyte layer.

Similarly, an anode, an anode support, and a cathode can be made in similar fashion using the metal oxides and other materials appropriate for such constructs as described herein and understood in the art. The present teachings also include the solid oxide cells (SOCs) that incorporate one or more electrolytes and electrodes (anodes and cathodes) as described herein. The products using the SOCs of the present teachings are also part of the disclosure.

In addition, the present teachings disclose methods for rapid and semi-automated fabrication of an anode supported SOC, such as an anode supported SOC that includes an ultra-thin electrolyte layer. The present teachings not only can reduce the production time of SOCs from multiple days to less than a few hours, enabling large-scale manufacturing, but also can ensure a more uniform distribution of the three-phase reaction interface.

The process provides for adjusting the coating sequence of the layer-by-layer green tape and avoids the lamination process, significantly improving production and adapting to industrial-scale continuous production. In addition, the process enables the production of an ultra-thin electrolyte layer. That is, the present teachings allow for the rapid production of layered, three-in-one (e.g., electrolyte-anode-anode support) green tape, for example, thin-layered, or ultra-thin layered three-in-one green tape. By eliminating the lamination step, the methods of the present teachings further reduce material waste.

The present teachings can leverage efficient mixing capabilities that can be realized by using acoustic resonance energy, thus enabling preparation of a uniform, well-dispersed slurry, often in a few hours and without waste. The method can preserve particle size and morphology of the starting material, for example, an electrolyte particulate, or an anode particulate, or a cathode particulate or an anode support particulate. In contrast, the traditional ball milling process is time-consuming, typically taking over twenty-four hours, for a result that includes significant loss of raw material due to grinding of the media.

As used herein, “low-frequency, high-intensity acoustic energy” generally refers to a form of energy generated by sound waves at low frequencies but with high power, used to enhance mixing and dispersion of materials. Low-frequency typically is between about 20 hertz (Hz) to about 100 kHz. High-intensity typically is greater than about 1 Watt per square centimeter (W/cm2) up to about 1000W/cm2.

As used herein, “high acceleration” generally refers to a condition of rapid change in velocity, applied during the mixing process to improve the uniformity of the mixture. High acceleration typically is multiples of gravitational acceleration (“g”=9.81 m/s2) or “G,” where multiples typically are between about 10 G to about 120 G.

As used herein, “electrolyte particulates” or “electrolyte particulate material” generally refers to a powdered electrolyte material as described herein, such as YSZ (yttria-stabilized zirconia), used to form the electrolyte layer in the solid oxide cell. A material can be referred to herein as a “particulate” or a “powder,” with those words used interchangeably unless the context dictates otherwise.

As used herein, “plasticizer” generally refers to a substance added to a mixture to enhance flexibility and decrease brittleness, thereby aiding the casting process.. A plasticizer can be a fugitive plasticizer, meaning that it is burned out during the sintering process so that it is not present in the final solid sintered electrode product.

As used herein, “binder” generally refers to a material used to hold particles together in a mixture, providing structural integrity during processing. A binder can be a fugitive binder, meaning that it is burned out during the sintering process so that it is not present in the final solid sintered electrode product.

As used herein, “slurry” generally refers to a semi-liquid mixture of solid particles, often suspended in a liquid, used as an intermediate material in the fabrication process.

As used herein, “de-gassing” generally refers to the process of removing trapped air or gas bubbles from a liquid or slurry, and can be undertaken to ensure uniformity and prevent defects in the final product.

As used herein, “casting” generally refers to a manufacturing process in which a liquid or slurry is poured into a mold or onto a surface to form a solid layer upon drying or curing.

As used herein, “electrolyte layer” generally refers to a layer of electrolyte material that conducts ions, i.e., protons or H+s, and oxygen ions or O2−s, serving as a central component of a solid oxide cell.

As used herein, a “thin electrolyte layer” generally refers to a layer of electrolyte material between about 5 μm and about 25 μm in thickness, for example, between about 8 μm and about 25 μm in thickness. A thin electrolyte layer conducts ions, serving as a central component of a solid oxide cell.

As used herein, an “ultra-thin electrolyte layer” generally refers to a layer of electrolyte material between about 1 μm to about 5 μm in thickness. An ultra-thin electrolyte layer conducts ions, serving as a central component of a solid oxide cell.

As used herein, “anode particulate” or “anode particulate material” generally refers to a powdered anode material used to form the anode layer, which facilitates the oxidation reaction in a solid oxide cell.

As used herein, “anode layer” generally refers to a layer of material adjacent to the electrolyte layer, responsible for the electrochemical oxidation reaction in the solid oxide cell.

As used herein, “anode support particulate” or “anode support particulate material” generally refers to a powdered anode support material used to form the anode support layer, providing structural support to the anode layer.

As used herein, “anode support layer” generally refers to a layer adjacent to the anode layer, designed to provide mechanical stability and support to the solid oxide cell structure.

As used herein, “three-layered anode supported anode-electrolyte structure” generally refers to a composite structure that includes an electrolyte layer, an anode layer, and an anode support layer, forming a structural component of the solid oxide cell.

As used herein, “sintering” generally refers to a thermal process that involves heating a material to a temperature below the material's melting point to bond particles together, thereby enhancing strength and density.

As used herein, “barrier layer” generally refers to a protective layer applied to the sintered electrolyte layer to prevent chemical interactions and enhance the performance of the solid oxide cell.

As used herein, “cathode particulate” or “cathode particulate material” generally refers to a powdered cathode material used to form the cathode layer, which facilitates the reduction reaction in a solid oxide cell.

As used herein, “cathode layer” generally refers to a layer applied to the barrier layer, responsible for the reduction reaction in the solid oxide cell.

As used herein, “YSZ” generally refers to yttria-stabilized zirconia, a ceramic material commonly utilized as an electrolyte in solid oxide cells due to the material's high ionic conductivity and stability at elevated temperatures.

As used herein, “green tape” generally refers to a specialized adhesive tape, typically made from a polyimide material, that is colored green and used to securely bond components within the battery pack due to its heat-resistant properties and compatibility with battery chemicals; essentially acting as insulation and protection for the battery's internal components of a battery. Note that it is not necessary that the adhesive tape be green. That is, the term “green tape,” as used herein, is meant to signify embodiments of adhesive tape that will generally exhibit the functionality as described herein.

As used herein, “ceramic” generally refers to an inorganic, non-metallic solid formed from a composition that includes metal oxides, metal nitrides, metal carbides, or metal oxynitrides. A ceramic forms by heating the composition to a temperature sufficient to cause densification, grain growth, or solid-state bonding of particulate material. A ceramic exhibits ionic or electronic conductivity, thermal stability, and mechanical rigidity under elevated-temperature operating conditions associated with solid oxide cells. Generally, ceramics do not exhibit carbon-hydrogen bonds, do not exhibit free-electron conduction like metals, have high melting points, exhibit hardness and brittleness and are chemically stable at high temperatures. Some non-limiting examples include zirconia (ZrO₂), yttria-stabilized zirconia (YSZ), ceria (CeO₂), alumina (Al₂O₃) and perovskites (LSM, LSCF, BSCF, etc.).

As used herein, “sintered ceramic” generally refers to a solid inorganic material formed by heating a particulate ceramic composition to a temperature below the melting point of the composition to cause bonding of adjacent particulates through solid-state diffusion. A sintered ceramic exhibits a continuous grain structure, mechanical rigidity, and thermal stability under the elevated-temperature conditions associated with solid oxide cell operation. A sintered ceramic can include residual porosity or can form as a dense structure depending on the processing temperature and the particulate composition.

As used herein, “dense ceramic electrolyte” generally refers to a ceramic layer that exhibits a continuous, non-porous structure that supports ionic transport at elevated temperature. A dense ceramic electrolyte includes a sintered ceramic material that defines substantially no interconnected porosity through the thickness of the layer. A dense ceramic electrolyte maintains gas separation between adjacent electrode layers in a solid oxide cell and provides a continuous path for oxygen-ion conduction or proton conduction depending on the ceramic composition.

As used herein, “solid oxide cell” (“SOC”) generally refers to an electrochemical structure that generates an electrical output or a chemical output through reactions that occur across a solid electrolyte. The structure includes a solid electrolyte between an anode layer and a cathode layer. The electrolyte can be ceramic. The structure operates at an elevated temperature and enables ionic transport through the solid electrolyte without use of a liquid phase.

As an example, a solid oxide cell can include a zirconia-based ceramic electrolyte between a nickel-containing anode layer and a lanthanum-strontium-manganite cathode layer. The example generates an electrical current when a fuel stream contacts the anode layer and when an oxidizer stream contacts the cathode layer. Other examples include structures with a scandia-stabilized zirconia electrolyte, a ceria-based electrolyte, a cobaltite-based cathode, or a perovskite-based anode. Each structure includes a solid ceramic electrolyte between an anode layer and a cathode layer and operates at an elevated temperature that enables ionic transport.

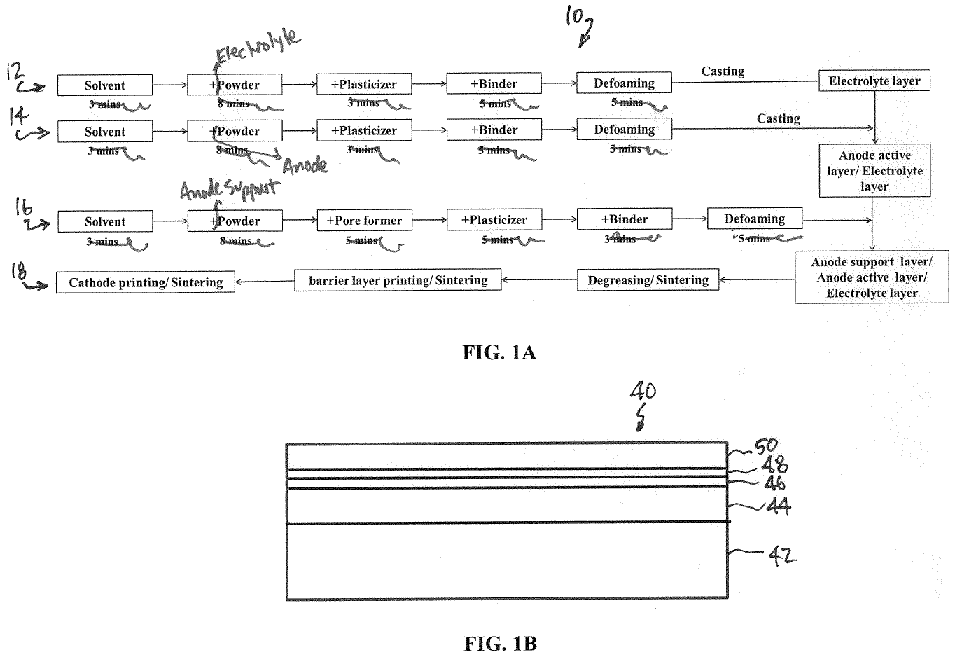

Referring to FIG. 1B, a schematic of an embodiment of an SOC is depicted. The SOC 10 includes an anode support layer 42, an anode layer 44, an electrolyte layer 46, a barrier layer 48, and a cathode layer 50. The SOC structure usually is sintered in its final form.

### Electrolytes

The electrolytes of the present teachings can include a thin electrolyte layer, which can be an ultra-thin electrolyte layer. The electrolyte particulates can be formed using metal oxide solid solution including one or more metal oxides selected from gadolinium (Gd) oxide, cerium (Ce) oxide, yttrium (Y) oxide, scandium (Sc) oxide, zirconium (Zr) oxide, hafnium (Hf) oxide, niobium (Nb) oxide, tantalum (Ta) oxide, calcium (Ca) oxide, strontium (Sr) oxide, barium (Ba) oxide, praseodymium (Pr) oxide, neodymium (Nd) oxide, samarium (Sm) oxide, europium (Eu) oxide, gadolinium (Gd) oxide, terbium (Tb) oxide, dysprosium (Dy), holmium (Ho) oxide, erbium (Er) oxide, thulium (Tm) oxide, and ytterbium (Yb) oxide. In various embodiments, an electrolyte can include two metal oxides, two or more metal oxides, three metal oxides, three or more metal oxides, four metal oxides, four or more metal oxides, five metal oxides, or five or more metal oxides from this list. In some embodiments, the electrolyte includes yttria-stabilized zirconia (YSZ) particulates. In certain embodiments, the electrolyte layer includes gadolinium-doped ceria (GDC) particulates. In particular embodiments, the electrolyte layer includes samarium-doped ceria or scandium-stabilized zirconia. In some embodiments, the electrolyte layer includes yttrium doped barium cerate-zirconate (BCZY). In certain embodiments, the electrolyte layer includes yttrium and ytterbium doped barium cerate-zirconate (BCZYYb).

In various embodiments, the electrolyte, when formed into a layer, can have a thickness less than or equal to 100 μm, for example, less than or equal to 95 μm, less than or equal to 90 μm, less than or equal to 85 μm, less than or equal to 80 μm, less than or equal to 75 μm, less than or equal to 70 μm, less than or equal to 65 μm, less than or equal to 60 μm, or less than or equal to 55 μm. In some embodiments, the electrolyte layer can have a thickness less than or equal to 50 μm, for example, less than or equal to 45 μm, less than or equal to 40 μm, less than or equal to 35 μm, or less than or equal to 30 μm. In some embodiments, an ultra-thin electrolyte layer can have a thickness less than or equal to 25 μm, for example, less than or equal to 20 μm, less than or equal to 15 μm, less than or equal to 10 μm. In particular embodiments, the electrolyte layer can be about 10 μm, or less than or equal to 9 μm, less than or equal to 8 μm, less than or equal to 7 μm, less than or equal to 6 μm, less than or equal to 5 μm, less than or equal to 4 μm, less than or equal to 3 μm, less than or equal to 2 μm, or less than or equal to 1 μm. In each of these examples with upper limits, the lower limit for the thickness of an electrolyte layer, such as an ultra-thin electrolyte layer, is at least about 0.1 μm, or at least about 0.3 μm, or at least about 0.5 μm.

In various embodiments, an ultra-thin electrolyte layer can be an acoustic energy slurry-formed electrolyte layer. Using acoustic energy on the slurry of metal oxides, plasticizer, binder, and pore former, when present, can facilitate uniform dispersion and casting of the particulates, resulting in a more uniform and evenly dispersed material for better performance.

In various embodiments, the electrolyte layer can be integrated into a multi-layer solid oxide cell structure, where the electrolyte layer is sandwiched between an anode layer and a cathode layer, where each can be formed from sintered particulate materials such as described herein.

In certain embodiments, the electrolyte layer can be the first layer formed in the structure of an SOC. In such a case, the electrolyte layer can be formed on a variety of substrates having the appropriate properties, for example, Mylar film, silicon coated Mylar film, glass or Kapton.

### Electrodes

The electrodes of the present teachings can include an anode, such as an anode layer, which can be an ultra-thin anode layer. The anode particulates can be formed of one or more metal oxides selected gadolinium (Gd) oxide, cerium (Ce) oxide, yttrium (Y) oxide, scandium (Sc) oxide, zirconium (Zr) oxide, hafnium (Hf) oxide, niobium (Nb) oxide, tantalum (Ta) oxide, calcium (Ca) oxide, strontium (Sr) oxide, barium (Ba) oxide, praseodymium (Pr) oxide, neodymium (Nd) oxide, samarium (Sm) oxide, europium (Eu) oxide, gadolinium (Gd) oxide, terbium (Tb) oxide, dysprosium (Dy) oxide, holmium (Ho) oxide, erbium (Er) oxide, thulium (Tm) oxide, and ytterbium (Yb) oxide. In various embodiments, an anode can include two metal oxides, two or more metal oxides, three metal oxides, three or more metal oxides, four metal oxides, four or more metal oxides, five metal oxides, or five or more metal oxides from this list.

In some embodiments, the anode particulate material includes of nickel (Ni) oxide and another listed metal oxide solid solution. The metal oxide solid solution can share a common metal oxide with the electrolyte. For example, if YSZ is used as electrolyte, anode composition should be NiO and YSZ. If GDC is used as electrolyte, the anode composition should be NiO and GDC. If BCZYYb is used as electrolyte, the anode composition should be NiO and BCZYYb.

In various embodiments, the anode, when formed into a layer, can have a thickness of about 150 μm, or less, such as less than or equal to 145 μm, less than or equal to 140 μm, less than or equal to 135 μm, less than or equal to 130 μm, less than or equal to 125 μm, less than or equal to 120 μm, less than or equal to 115 μm, less than or equal to 110 μm, or less than or equal to 105 μm. In some embodiments, the anode layer has a thickness less than or equal to 100 μm, less than or equal to 95 μm, less than or equal to 90 μm, less than or equal to 85 μm, less than or equal to 80 μm, less than or equal to 75 μm, less than or equal to 70 μm, less than or equal to 65 μm, less than or equal to 60 μm, or less than or equal to 55 μm. In certain embodiments, an ultra-thin anode layer can have a thickness less than or equal to 50 μm, less than or equal to 45 μm, less than or equal to 40 μm, less than or equal to 35 μm, less than or equal to 30 μm, less than or equal to 25 μm, less than or equal to 20 μm, less than or equal to 15 μm, or less than or equal to 10 μm. In each of these examples with upper limits, the lower limit for the thickness of an anode layer, such as an ultra-thin anode layer, is at least about 0.5 μm, or at least about 1 μm, or at least about 2 μm.

In various embodiments, the anode layer can be integrated into a multi-layer solid oxide cell structure, where the anode layer is adjacent an electrolyte layer, opposite a cathode layer, where each can be formed from sintered particulate materials such as described herein.

In various embodiments, the anode can have a supporting layer, i.e., an anode supporting layer, which can be an ultra-thin anode supporting layer, adjacent to the anode layer to provide structural integrity to the device. The anode support layer provides mechanical strength and dimensional stability to the entire cell. Because the electrolyte (usually made of yttria-stabilized zirconia, YSZ) is thin often less than 10 μm, it cannot sustain itself mechanically.

In certain embodiments, the solid oxide cell includes an anode support layer that provides both structural and electrochemical functionality to the cell. The anode support layer serves as a mechanically robust substrate upon which an anode layer, a dense thin electrolyte layer and a cathode layer can be formed, thereby imparting dimensional stability to the cell during fabrication and operation at elevated temperatures.

The anode support particulates can be formed of one or more metal oxides selected from gadolinium (Gd) oxide, cerium (Ce) oxide, yttrium (Y) oxide, scandium (Sc) oxide, zirconium (Zr) oxide, hafnium (Hf) oxide, niobium (Nb) oxide, tantalum (Ta) oxide, calcium (Ca) oxide, strontium (Sr) oxide, barium (Ba) oxide, praseodymium (Pr) oxide, neodymium (Nd) oxide, samarium (Sm) oxide, europium (Eu) oxide, gadolinium (Gd) oxide, terbium (Tb) oxide, dysprosium (Dy) oxide, holmium (Ho) oxide, erbium (Er) oxide, thulium (Tm) oxide, and ytterbium (Yb) oxide. In various embodiments, the anode support particulates can include two metal oxides, two or more metal oxides, three metal oxides, three or more metal oxides, four metal oxides, four or more metal oxides, five metal oxides, or five or more metal oxides from this list.

In some embodiments, an anode supporting particulate material, when formed into a layer, i.e., an anode supporting layer, can have a thickness of about 150 μm, or less, such as less than or equal to 145 μm, less than or equal to 140 μm, less than or equal to 135 μm, less than or equal to 130 μm, less than or equal to 125 μm, less than or equal to 120 μm, less than or equal to 115 μm, less than or equal to 110 μm, or less than or equal to 105 μm. In some embodiments, the anode supporting layer has a thickness less than or equal to 100 μm, less than or equal to 95 μm, less than or equal to 90 μm, less than or equal to 85 μm, less than or equal to 80 μm, less than or equal to 75 μm, less than or equal to 70 μm, less than or equal to 65 μm, less than or equal to 60 μm, or less than or equal to 55 μm. In certain embodiments, an ultra-thin anode supporting layer can have a thickness less than or equal to 50 μm, less than or equal to 45 μm, less than or equal to 40 μm, less than or equal to 35 μm, less than or equal to 30 μm, less than or equal to 25 μm, less than or equal to 20 μm, less than or equal to 15 μm, or less than or equal to 10 μm. In each of these examples with upper limits, the lower limit for the thickness of an anode supporting layer, such as an ultra-thin anode supporting layer, is at least about 0.5 μm, or at least about 1 μm, or at least about 2 μm.

In various embodiments, the anode supporting layer can be integrated into a multi-layer solid oxide cell structure, where the anode supporting layer is adjacent an anode layer, opposite an electrolyte layer as shown in FIG. 1B, where anode supporting layer 42 is adjacent the anode 44, which has an electrolyte 46 on its opposite face. Each of these layers can be formed from sintered particulate materials such as described herein.

The electrodes of the present teachings can include a cathode, such as a cathode layer, which can be an ultra-thin cathode layer. The cathode particulates can be formed of one or more metals selected from perovskite-type oxides. In some embodiments, the cathode particulates include metal oxides selected from the group consisting of nickel (Ni) oxide, nickel oxide-based cermets, strontium (Sr) oxide, lanthanum (La) oxide, manganese (Mn) oxide, cobalt (Co) oxide, iron (Fe) oxide, zinc (Zn) oxide, praseodymium (Pr) oxide, barium (Ba) oxide, gadolinium (Gd) oxide, and samarium (Sm) oxide. These elements can be incorporated in various combinations to form advanced oxide materials such as strontium-doped lanthanum manganite (LSM), lanthanum strontium cobalt ferrite (LSCF), lanthanum strontium iron manganese cobalt oxide (LSFMC), lanthanum strontium zinc iron oxide (LSZF), praseodymium barium strontium cobalt iron oxide (PBSCF), lanthanum strontium cobaltite (LSC), barium strontium cobalt ferrite (BSCF), gadolinium doped ceria, and samarium doped ceria (GDC/SDC). The selection and combination of these elements enable the tailoring of electrical, ionic, and catalytic properties for specific applications in solid oxide cells and related devices.

In various embodiments, the cathode, when formed into a layer, can have a thickness of about 150 μm, or less, such as less than or equal to 145 μm, less than or equal to 140 μm, less than or equal to 135 μm, less than or equal to 130 μm, less than or equal to 125 μm, less than or equal to 120 μm, less than or equal to 115 μm, less than or equal to 110 μm, or less than or equal to 105 μm. In some embodiments, the cathode layer has a thickness less than or equal to 100 μm, less than or equal to 95 μm, less than or equal to 90 μm, less than or equal to 85 μm, less than or equal to 80 μm, less than or equal to 75 μm, less than or equal to 70 μm, less than or equal to 65 μm, less than or equal to 60 μm, or less than or equal to 55 μm. In certain embodiments, an ultra-thin cathode layer can have a thickness less than or equal to 50 μm, less than or equal to 45 μm, less than or equal to 40 μm, less than or equal to 35 μm, less than or equal to 30 μm, less than or equal to 25 μm, less than or equal to 20 μm, less than or equal to 15 μm, or less than or equal to 10 μm. In each of these examples with upper limits, the lower limit for the thickness of a cathode layer, such as an ultra-thin cathode layer, is at least about 0.5 μm, or at least about 1 μm, or at least about 2 μm.

In various embodiments, with reference to FIG. 1B, the cathode layer can be integrated into a multi-layer solid oxide cell structure 40, where the cathode layer 50 is adjacent an electrolyte layer 46 (with a barrier layer 48 in-between), opposite an anode layer 44, where each can be formed from sintered particulate materials such as described herein.

The cathode layer can be directly adjacent to the electrolyte, or to a barrier layer applied to the electrolyte, for example, sintered electrolyte particulates, to assist in the electrochemical conversion process. In certain embodiments, the present teachings include an ultra-thin barrier (buffer) layer, which can include gadolinium doped ceria (GDC) and/or praseodymium and gadolinium co-doped ceria (PGCO). This layer can be applied in various ways including, but not limited to, printing the barrier layer.

### SOCs

Generally, electrolytes and anodes and cathodes fabricated according to the teachings herein can be used solely, or with other techniques to assemble an SOC as described herein and pictures in FIG. 1B. The SOCs can also be used in the assembly of an energy storage device or an electrochemical cell. Examples of energy storage devices include batteries, fuel cells, and other such devices

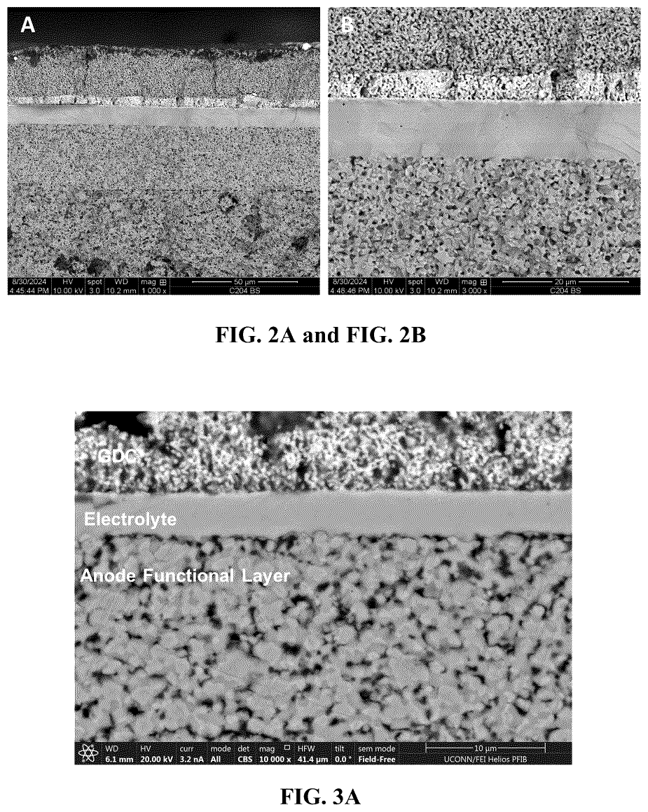

FIGS. 2A and 2B are scanning electron microscope (SEM) images at 1000× and 3000× magnification, respectively, of an SOC cross-section made in accordance with the present teachings. As can be seen, each of the layers of the SOC is distinct from the adjacent layer.

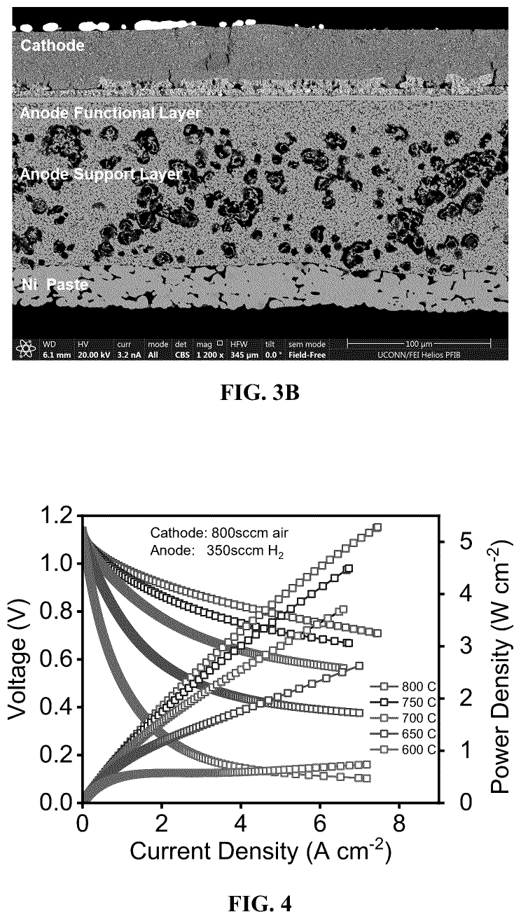

FIGS. 3A and 3B also are SEM images at 10,000× and 1200× magnification, respectively, of an SOC cross-section made in accordance with the present teachings. As can be seen, each of the labeled layers of the SOC is distinct from the adjacent layer, with an ultra-thin electrolyte layer between the anode and cathode.

### Methods of Making Electrolytes and Electrodes

In another aspect, the present teachings provide methods of making the electrolyte and electrode layers and the electrodes described herein such as assembling the different electrolyte, electrodes and any other layers in a particular order to create an SOC of the present teachings. The present teachings also provide for a method of manufacturing and assembling the electrolyte with the electrodes to form a multilayered SOC. In particular, the methods of making the electrolytes and electrodes described herein include processing, for example, mixing, the components of the slurry preparation of a particular electrolyte or electrode layer, for example, an electrolyte layer, or an anode layer, or an anode support layer, or a barrier layer, or a cathode layer using acoustic energy such as ResonantAcoustic® Mixing (“RAM”) from Resodyn Corporation, Butte, Montana. Generally, RAM is a bladeless mixing technology that uses sound energy and resonance to mix materials without mechanical means. RAM uses low-frequency, high-intensity acoustic energy and high acceleration to mix powders quickly, thoroughly, and accurately. RAM can also be advantageously used to defoam and/or de-aerate mixtures, for example, slurries, particularly after mixing.

RAM is used in the pharmaceutical and medical device industries. It can mix various types of materials, coat better than other technologies, and is efficient, gentle, and repeatable. RAM can also rapidly coat metal alloys with nanoparticles, coating more uniformly than mixtures derived from ball-milling, which is commonly used to process the components for electrode slurries.

FIG. 1 is a schematic flow chart diagram of an embodiment of the present teachings illustrating the fabrication of tape-cast slurry-made electrode layers to ultimately form an SOC. Of particular interest in the process is the reduction in time for preparation of the respective slurries for each electrode layer, or at least some of the core layers. The use of RAM achieves rapid and thorough mixing of the slurry or layers to be printed. RAM provides a repeatable, high-quality mixing process for the solid/liquid mixtures or slurries. Considered over the entire process, the methods of the present teachings can reduce the process time by about 100 times compared to current processing times. Further, the slurries prepared by these methods can uniformly disburse the solids within the solvent that can translate to good performance of the products made with these electrode layers. The payload capacity using this technique is up to 200 kg, or up to 300 kg, or up to 350 kg, or up to 400 kg, or up to 450 kg.

To further reduce the process times for the preparation of a three-layer structure or a complete SOC of the present teachings, each slurry preparation step could include RAM at an acceleration intensity of about 85 G, about 90 G, about 95 G, or about 100 G. If the process time is not a concern, RAM can be at a lower acceleration intensity, for example, about 75 G, about 70 G, about 65 G, about 60 G, about 55 G, or about 50 G. In addition, the premixing of the solvent and dispersant mixture and the premixing of combined electrode particulates, for example, NiO and YSZ, or mixing them simultaneously can further reduce the processing time.

Accordingly, in methods of fabricating a solid oxide cell (SOC) according to the present teachings, the methods can generally include mixing a dispersant in a solvent using low-frequency, high-intensity acoustic energy and high acceleration such as generated by RAM, to ensure uniform dispersion. The appropriate particulates (e.g., electrolyte particulates, anode particulates, anode support particulates, or cathode particulates), a plasticizer, and a binder can then be added to the mixture in sequence with RAM applied for a predetermined amount of time after each addition. The combined materials can be further mixed using RAM to produce the respective homogeneous slurry. This slurry can be subsequently degassed to remove any entrapped air or gases. The de-gassed slurry can be cast to form an electrolyte layer, an anode layer, an anode support layer, or a cathode layer which can be in an ultra-thin format. Each layer can be disposed one atop the other in the desired sequence to form the SOC. For example, the anode layer can be disposed on one surface of the electrolyte layer, while the cathode layer can be disposed on an opposing surface of the electrolyte layer to form a SOC.

The amount of solvent in electrolyte and electrode slurries is a formulation parameter that can affect slurry viscosity, coating quality, drying behavior, and ultimately electrode microstructure. The solvent serves primarily to dissolve or disperse the binder and to create a workable suspension of the active particulate material and any additives. After the slurry is coated onto the appropriate substrate, which could be another layer of the SOC, the solvent is evaporated, leaving behind the solid electrode film.

Solvents that are useful in the practice of the present teaching include liquid aprotic polar solvents such as water, propylene carbonate, ethylene carbonate, butyrolactone, acetonitrile, benzonitrile, nitromethane, nitrobenzene, sulfolane, dimethylformamide, N-methylpyrrolidone, or the like, or combinations includes at least one of the foregoing solvents. Polar protic solvents such as, but not limited to, water, methanol, acetonitrile, nitromethane, ethanol, propanol, isopropanol, butanol, or the like, or combinations includes at least one of the foregoing polar protic solvents can be used. Other non-polar solvents such as benzene, toluene, xylene, methylene chloride, carbon tetrachloride, hexane, diethyl ether, tetrahydrofuran, methyl ethyl ketone, or the like, or combinations includes at least one of the foregoing solvents can also be used. Co-solvents includes at least one aprotic polar solvent and at least one non-polar solvent can also be used.

In general, electrolyte and electrode slurries contain about 30% to about 60% solids, which means the solvent fraction typically makes up about 40% to about 70% of the total slurry mass. The exact ratio depends on several factors, including the viscosity of the binder solution, particle size distribution, mixing parameters, and the desired coating thickness.

In the preparation of electrolyte and electrode layers for electrochemical devices, binders (e.g., polymers) can play a role in determining both the mechanical integrity and the electrochemical performance of the final electrode. These polymers are incorporated into the slurry mixture along with active material particles and conductive additives to provide cohesion within the electrode film and adhesion to the current collector surface.

Binders can include polymers such as organic polymers and can be selected from a wide variety of thermoplastic polymers, blend of thermoplastic polymers, thermosetting polymers, or blends of thermoplastic polymers with thermosetting polymers. The organic polymer can also be a blend of polymers, copolymers, terpolymers, or combinations includes at least one of the foregoing organic polymers. The organic polymer can also be an oligomer, a homopolymer, a copolymer, a block copolymer, an alternating block copolymer, a random polymer, a random copolymer, a random block copolymer, a graft copolymer, a star block copolymer, a dendrimer, a polyelectrolyte (polymers that have some repeat groups that contain electrolytes), a polyampholyte (a polyelectrolyte having both cationic and anionic repeat groups), an ionomer, or the like, or a combination includes at last one of the foregoing organic polymers. The organic polymers have number average molecular weights greater than 10,000 grams per mole, preferably greater than 20,000 g/mole and more preferably greater than 50,000 g/mole.

Examples of thermoplastic polymers include a polyacrylic, a polycarbonate, a polyalkyd, a polystyrene, a polyolefin, a polyester, a polyamide, a polyaramid, a polyamideimide, a polyarylate, a polyurethane, an epoxy, a phenolic, a polysiloxane, a polyarylsulfone, a polyethersulfone, a polyphenylene sulfide, a polysulfone, a polyimide, a polyetherimide, a polytetrafluoroethylene, a polyetherketone, a polyether ether ketone, a polyether ketone, a polybenzoxazole, a polyoxadiazole, a polybenzothiazole, a polybenzothiazinophenothiazine, a polypyrazinoquinoxaline, a polypyromellitimide, a polyguinoxaline, a polybenzimidazole, a polyoxindole, a polyoxoisoindoline, a polydioxoisoindoline, a polytriazine, a polypyridazine, a polypiperazine, a polypyridine, a polypiperidine, a polytriazole, a polypyrazole, a polycarborane, a polyoxabicyclononane, a polydibenzofuran, a polyphthalide, a polyacetal, a polyanhydride, a polyvinyl ether, a polyvinyl thioether, a polyvinyl alcohol, a polyvinyl ketone, a polyvinyl halide, a polyvinyl nitrile, a polyvinyl ester, a polysulfonate, a polysulfide, a polythioester, a polysulfone, a polysulfonamide, a polyurea, a polyphosphazene, a polysilazane, a polyolefin, or the like, or a combination thereof.

Other examples of the organic polymers that can be used as binders or include polyacetals, polyolefins, polyacrylics, polycarbonates, polystyrenes, polyesters, polyamides, polyamideimides, polyarylates, polyarylsulfones, polyethersulfones, polyphenylene sulfides, polyvinyl chlorides, polysulfones, polyimides, polyetherimides, polytetrafluoroethylenes, polyetherketones, polyether etherketones, polyether ketone ketones, polybenzoxazoles, polyphthalides, polyanhydrides, polyvinyl ethers, polyvinyl thioethers, polyvinyl alcohols, polyvinyl ketones, polyvinyl halides, polyvinyl nitriles, polyvinyl esters, polysulfonates, polysulfides, polythioesters, polysulfones, polysulfonamides, polyureas, polyphosphazenes, polyethylene terephthalate, polybutylene terephthalate, polyurethane, polytetrafluoroethylene, perfluoroelastomers, fluorinated ethylene propylene, perfluoroalkoxyethylene, polychlorotrifluoroethylene, polyvinylidene fluoride, polysiloxanes, or the like, or a combination includes at least one of the foregoing organic polymers.

Typically, binder content ranges from about 0.5% to about 20% or about 15% or about 10% of the total solids in the slurry. Using too little binder can lead to cracking or delamination of the electrode film, whereas excess binder can reduce electrical conductivity and limit the amount of active material that can be loaded. Recent research has also focused on bio-based binders (such as alginate and chitosan) and conductive polymer binders (such as PEDOT:PSS and polypyrrole), which offer greener processing or improved electronic pathways. In all cases, the binder must strike a delicate balance between mechanical, chemical, and electrochemical properties, ensuring both processability and stable long-term performance of the electrode. Properties of the binder such as surface area, particle size, and density should be considered when determining the appropriate amount for a particular application.

In electrolyte and electrode slurry formulation, plasticizers are additives used to improve the flexibility, processability, and mechanical stability of the electrode film. While binders provide cohesion and adhesion, plasticizers modify the physical properties of the binder matrix—reducing brittleness, improving film formation, and enhancing coating uniformity. They work by intercalating between polymer chains, increasing molecular mobility and lowering the glass transition temperature (Tg) of the polymer, which makes the dried electrode film less prone to cracking or delamination during drying and cycling.

Plasticizers can include ethylene carbonate (EC), dimethyl carbonate (DMC), propylene carbonate (PC), succinonitrile (SN), and certain ionic liquids (for example, 1-ethyl-3-methylimidazolium bis(trifluoromethylsulfonyl)imide, or EMIM-TFSI). Emerging research also explores bio-based plasticizers such as triacetin, glycerol triacetate, and citric acid esters, which offer improved safety, lower volatility, and better environmental compatibility.

Typically, plasticizers are added in small proportions, usually about 1% to about 10% of the total solid or polymer content. Too little plasticizer can lead to brittle, cracked electrodes, while too much can cause film softening, poor adhesion, or leaching during cycling. Recent trends include the use of eco-friendly plasticizers, such as bio-based esters and ionic liquids, to replace conventional phthalates and improve sustainability and safety in electrode manufacturing. The amount of plasticizer needs to be adjusted based on the above and the particular application of the product.

Dispersants are additives used in electrolyte and electrode slurries and other particulate suspensions to prevent agglomeration and maintain uniform distribution of solids. A wide range of dispersants can be used depending on the material system and solvent.

Dispersants can include polymeric dispersants such as described herein, including polyacrylic acid (PAA), polyacrylates, polycarboxylates, and polyethylene oxide-polypropylene oxide block copolymers, which stabilize particles through steric hindrance. Surfactant-based dispersants include small molecules such as sodium dodecyl sulfate (SDS), sodium hexametaphosphate, alkylbenzene sulfonates, and phosphate esters, which stabilize particles via electrostatic or electro-steric mechanisms. Some dispersants combine polymeric backbones with functional groups that provide both steric and electrostatic stabilization, such as graft copolymers and comb-shaped polymers commonly used in high-solids slurries for inks, paints, and battery electrodes. In aqueous systems, CMC (carboxymethyl cellulose) and sodium polyacrylate also serve dual roles as dispersants and rheology modifiers, enhancing particle dispersion while controlling slurry viscosity. Emerging research has introduced bio-based dispersants, including alginate derivatives and modified polysaccharides, which offer environmentally friendly alternatives for both aqueous and organic solvent systems. Overall, the choice of dispersant depends on particle type, solvent, desired stability, and the specific application, balancing electrostatic, steric, and chemical compatibility considerations.

In electrolyte and electrode slurries, the dispersant content is typically much lower than that of the active material, binder, or solvent, but it plays a crucial role in maintaining particle stability and uniformity. Generally, dispersants can be used in the range of about 0.5% to about 5% relative to the total solids in the slurry, though the exact amount can depend on the particle type, surface chemistry, solvent system, and solids loading.

In various embodiments, the electrolyte slurry can include about 20% to about 80% metal oxides, about 2% to about 8% binder, about 1% to about 4% plasticizer, and about 0.01% to about 0.1% dispersant, based on the total weight of the slurry. In some embodiments, the anode slurry can include about 45% to about 75% metal oxides, about 1% to about 10% binder, about 1% to about 5% plasticizer, and about 0.5% to about 4% dispersant, based on the total weight of the slurry. In certain embodiments, the cathode slurry can include about 35% to about 65% metal oxides, about 2% to about 9% binder, about 0.05% to about 1% plasticizer, and about 30% to about 60% dispersant, based on the total weight of the slurry. In particular embodiments, the anode support slurry can include about 25% to about 65% metal oxides, about 1% to about 5% binder, about 15% to about 35% pore former, about 1% to about 5% plasticizer, and about 0.05% to about 4% dispersant, based on the total weight of the slurry.

Reference is now made to Examples 1 and 2, which contains a more detailed description of the fabrication of an SOC according to the present teachings.

### Methods of Using Electrolytes and Electrodes

In yet another aspect, the present teachings provide methods of using the electrolytes and electrodes described herein as well as SOCs including an electrolyte or an electrode component of the present teachings.

In use, the solid oxide cell (SOC) can be operated by flowing an electrical current through the cell to facilitate energy conversion or storage processes. The SOC can be incorporated into various articles of manufacture, such as batteries, fuel cells, or electrolyzers, depending on the desired application. During operation, the SOC can function as a fuel cell to generate electricity from chemical fuels, as an electrolyzer to produce chemical products through electrolysis, or as a component in energy storage devices to store and release electrical energy as needed. The method of using the SOC can include connecting the cell to an external electrical circuit, supplying reactants or electrolytes as appropriate for the specific device, and controlling the operating conditions such as temperature, pressure, and current flow to optimize performance and efficiency. The versatility of the SOC allows the solid oxide cell to be adapted for a wide range of energy conversion and storage applications, providing reliable operation in various environments and system configurations.

Generally, electrolytes and anodes and cathodes fabricated according to the teachings herein can be used with other techniques for assembly of an energy storage device or electrochemical cells. Examples of energy storage devices include batteries, fuel cells and other such devices.

SOCs fabricated according to the methods described herein were evaluated and tested using various techniques as described below with reference to the figures. The SOFC cell performance was evaluated using a high temperature test station equipped with controlled gas flows at different temperatures with a potentiostat.

The products were examined with SEM to validate the thickness, structure, and porosity of the different layers during construction and after completion. See FIGS. 2A, 2B, 3A and 3B. The typical porosity of an anode supported layer can be about 30% to about 50%. The porosity of an anode functional layer can be about 10% to about 30%. The porosity of a buffer layer can be about 10% to about 30%. The porosity of a cathode layer can be about 25% to about 40%. The electrolyte layer can be a dense ceramic layer. The porosity of each layer can be adjusted by varying the amount and selection of pore former and binder during processing.

FIG. 4 shows the current density (I)—cell voltage (V)—output power density (P) relation of a fuel cell measured under the temperatures of 600 oC to 800 oC. The measurement is conducted with a Biologic VMP3 multi-channel potentiostat (Bio-Logic USA, Knoxville, TN) equipped with external current boosters. The measurement is conducted with linear sweep voltammetry with a scan rate of 5 mV/s in the four-probe approach. The output power density is evaluated as the product between I and V. The cell can achieve supreme power density of 5 W/cm2 at a cell voltage of 0.75V at 800 oC. The SOC's electrochemical impedance was measured using cell electrochemical impedance spectroscopy (EIS) to evaluate the resistance that is contributed from the electrolyte and electrodes at various temperatures. The perturbation current for EIS measurement has an amplitude of 10 mA and the frequency from 100 kHz to 0.1 Hz.

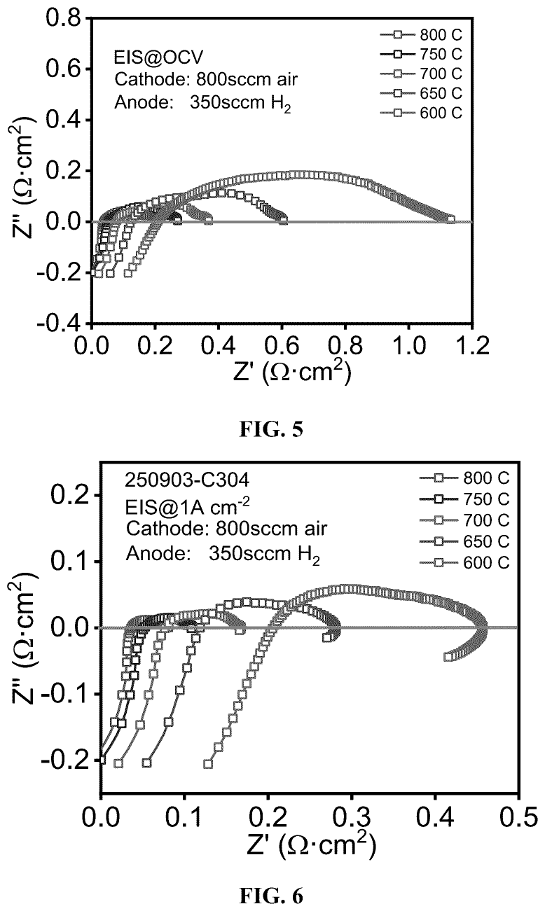

FIG. 5 shows the EIS measured under open circuit voltage (OCV) and FIG. 6 shows the EIS measured under a constant direct discharging current of 1 A/cm2. The ohmic resistance of the cell is the high frequency interception of the impedance at the real axis, which is considered to be mostly contributed from the electrolyte. The ohmic resistance of the cell reaches 0.03 Ohm cm2, which is very close to the theoretical value of 0.019 Ohm cm2 of a 4 μm 8YSZ dense electrolyte.

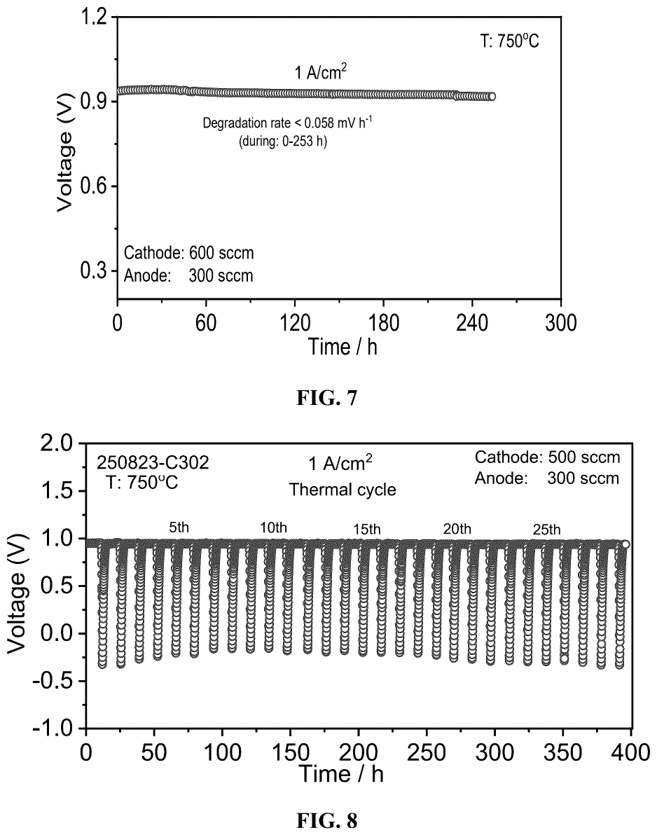

Long-term stability testing was undertaken. The tests were conducted at a constant load to monitor voltage degradation over time. FIG. 7 is a graph of fuel cell stability evaluation at a temperature of 750 oC,. The degradation rate of the fuel cell as measured by its voltage was less than 0.058 mV/h over 253 hours. FIG. 8 is a graph of a fuel cell thermal stability evaluation, where the fuel cell undergoes thermal cycling between the temperatures of 400 oC to 750oC. As can be seen, the fuel cell did not substantially degrade on thermal cycling over 400 hours.

### EXAMPLES

### Example 1. Fabrication of an Exemplary Solid Oxide Cell (SOC)

In a first step, slurry preparation is undertaken.

Electrolyte layer: 8 g. ethanol, 8 g. MEK, and 0.2 g. dispersant (Hypermer KD-1) were added to a mixing jar. The materials were processed by ResonantAcoustic® Mixing (RAM) for 5 mins at 60 Hz and 100 G.

Then, 35 g. 8-YSZ powder, 2 g. plasticizer and 3 g. binder were added to the solvent system as shown in FIG. 1A, line 12. Subsequently, the slurry was de-aired by vacuumizing with the reading of 300 torr for 5 min at 10 G. The slurry was cast on a Malar carrier with a setting of a doctor blade at 25 μm and the carrier forwarding speed of 10 mm/min. After drying in an air flow of 500 mL/min for 3 minutes, the tape was ready for use.

Anode active layer and anode supporting layer: The slurries of the anode active layer and the anode supporting layer were also prepared according to the method for preparing the electrolyte layer slurry provide above. Anode active layer: 10 g. ethanol, 10 g. MEK and 0.25 dispersant (Hypermer KD-1) were added to a mixing jar. The materials were processed by ResonantAcoustic® Mixing (RAM) for 5 mins at 60 Hz and 100 G. 17 g. 8-YSZ powder, 20 g. NiO, 3 g. plasticizer and 3.8 g. binder were added to the solvent system as shown in FIG. 1A, line 14. Anode supporting layer: 15 g. ethanol, 15 g. xylene and 2 g. dispersant (Hypermer KD-1) were added to a mixing jar. The materials were processed by ResonantAcoustic® Mixing (RAM) for 5 mins at 60 Hz and 100 G. 38 g. 3-YSZ powder, 38 g. NiO, 15 g. pore former, 5 g. plasticizer and 7 g. binder were added to the solvent system as shown in FIG. 1A, line 16. Then, an anode active layer was cast onto the dried electrolyte layer. The thickness of the anode active layer was 150 μm. After drying for 30 min, the anode support layer was cast onto the anode active electrolyte layer.

Subsequently, a sintering procedure was undertaken. In this step, a two-step sintering approach is used to ensure the organic components burnt out completely before the ceramic materials sintered together with controlled shrinkage rate and final sintering density to avoid severe warping and a broken or a cracked layer. The pre-sintering step is conducted in a box furnace with the sintering temperature up to 1080 oC. for one hour. The final sintering step is to bring the parts to a flat and mechanically strong form with fully dense YSZ layer and proper densities of anode support layer and active function layer. To do so, the pre-sintered samples were added proper alumina or zirconia weights, about 50 grams per square centimeter of sample, and heated to between about 1350 oC to about 1375 oC. for 3 hours.

Barrier layer and cathode layer: In the next step, a Pr0.1Gd0.1Ce0.8O1.9barrier layer ink was screen-printed on the sintered YSZ surface of the three-layer structure created above. The four-layer structure was then fired at 1200 oC for 3 h. Subsequently, the LSCF-GDC cathode was screen-printed on the barrier layer surface and sintered at 1050 oC for 3 h. The SOC is successfully prepared after completing the above steps.

SOC properties: SOC electrochemical measurements of samples were. The cells with a diameter of about 1 inch were electrically connected to Pt wires in a 4-probe configuration and sealed on an alumina tube with glass paste. A quarter-inch alumina tube was used to provide air flow to the cathode. The chamber of the sealed tube was purged by nitrogen before NiO/YSZ anode was reduced by the hydrogen/nitrogen mixture for 1 hour. During electrochemical measurements, the Ni/YSZ anode was supplied with 3% humidified H2 at a rate of 200 sccm and the cathode was fed with 400 sccm air. The electrochemical impedance spectrum (EIS) and current-voltage (i-V) curve were obtained by using a Biologic VMP3 multi-channel potentiostat (Bio-Logic USA, Knoxville, TN) equipped with external current boosters.

### Example 2. Manufacture of an Exemplary SOC

FIG. 1 is a schematic flow chart diagram of an embodiment of the present teachings illustrating the fabrication of tape-cast slurry-made electrode layers to ultimately form an SOC. Of particular interest in the process is the reduction in time for preparation of the respective slurries for each electrode layer, or at least some of the core layers. The use of RAM achieves rapid and thorough mixing of the slurry or layers to be printed. RAM provides a repeatable, high-quality mixing process for the solid/liquid mixtures or slurries. Considered over the entire process, the methods of the present teachings can reduce the process time by about 100 times compared to current processing times. Further, the slurries prepared by these methods can uniformly disburse the solids within the solvent that can translate to good performance of the products made with these electrode layers. The payload capacity using this technique is up to 200 kg, or up to 300 kg, or up to 350 kg, or up to 400 kg, or up to 450 kg.

To further reduce the process times for the preparation of a three-layer structure or a complete SOC of the present teachings, each slurry preparation step could include RAM at an acceleration intensity of about 85 G, about 90 G, about 95 G, or about 100 G. If the process time is not a concern, RAM can be at a lower acceleration intensity, for example, about 75 G, about 70 G, about 65 G, about 60 G, about 55 G, or about 50 G. In addition, the premixing of the solvent and dispersant mixture and the premixing of combined electrode particulates, for example, NiO and YSZ, or mixing them simultaneously can further reduce the processing time.

Accordingly, in methods of fabricating a solid oxide cell (SOC) according to the present teachings, the methods can generally include mixing a dispersant in a solvent using low-frequency, high-intensity acoustic energy and high acceleration such as generated by RAM, to ensure uniform dispersion. The appropriate particulates (e.g., electrolyte particulates, anode particulates, anode support particulates, or cathode particulates), a plasticizer, optionally a pore former, and a binder can then be added to the mixture in sequence with RAM applied for a predetermined amount of time after each addition. The combined materials can be further mixed using RAM to produce the respective homogeneous slurry. This slurry can be subsequently degassed to remove any entrapped air or gases. The de-gassed slurry can be cast to form an electrolyte layer, an anode layer or a cathode layer which can be in an ultra-thin format. Each layer can be disposed one atop the other in the desired sequence to form the SOC. For example, the anode layer can be disposed on one surface of the electrolyte layer, while the cathode layer can be disposed on an opposing surface of the electrolyte layer to form a SOC.

Referring to FIG. 1A, certain embodiments of the methods of making an SOC 10 more specifically include (starting with the row labeled 12) mixing a dispersant in a solvent of methyl ethyl ketone (MEK) and ethanol and subjecting the mixture to RAM for 3 minutes at an acceleration intensity of 80 G. Simultaneously, the electrolyte particulates of 8YSZ are mixed in a solvent using RAM for 5 minutes at 80 G. The two mixture are combined and subjected to RAM for 8 minutes at 80 G. A plasticizer can be added with the resulting mixture subjected to RAM for 3 minutes at 80 G. A binder can be added to the mixture and subjected to RAM for 5 minutes at 80 G. Finally, the completed slurry is defoamed using RAM for 1 minute at 20 G. The electrolyte layer is now ready for casting into an appropriate shape such as a film on a substrate, for example, for the preparation of an SOC. The cast film can define the electrolyte layer, which can be an ultra-thin electrolyte layer.

The next flow line down 14 represents the preparation of the anode layer, also referred to as the active anode layer in comparison to the anode support layer. Similar to the preparation of an electrolyte slurry, the preparation of an anode slurry follows a similar process. In various embodiments, a similar process can be employed to fabricate an anode layer, where a dispersant can be mixed in a solvent, followed by addition of an anode powder, a plasticizer, and a binder. The mixture can be processed with acoustic energy to create a slurry. After de-gassing, the slurry can be cast directly onto the previously formed electrolyte layer to create the anode layer. Alternatively, the anode slurry can be cast on an appropriate substrate, for example, to create a separate anode layer for application in various devices.

More specifically, in some embodiments, the preparation of the anode material slurry includes mixing a dispersant in a solvent of methyl ethyl ketone MEK and ethanol, then subjecting the mixture to RAM for 3 minutes at an acceleration intensity of 80 G. Simultaneously, the anode particulates of NiO and 3YSZ are mixed in a solvent using RAM for 5 minutes at 80 G. It should be understood that weight percentages of NiO and 3YSZ can be adjusted for different applications. The dispersant mixture and anode particulates mixture are combined and subjected to RAM for 8 minutes at 80 G. A plasticizer can be added with the resulting mixture subjected to RAM for 3 minutes at 80 G. A binder can be added with the resulting mixture subjected to RAM for 5 minutes at 80 G. The anode slurry is then defoamed and/or de-aerated using RAM for 1 minute at 20 G. The anode slurry is then ready for casting into an independent anode shape, or casting on an electrolyte layer, for example, as formed above.

In various embodiments, an anode support layer can be fabricated (along flow line 16) by mixing a dispersant in a solvent, and adding an anode support powder, a plasticizer, and a binder. Mixing the anode support mixture using acoustic energy to form anode support slurry. The anode support slurry then can be de-gassed. The de-gassed anode support slurry can be cast onto the anode layer, resulting in a three-layered anode supported anode-electrolyte structure. This three-layered structure can then be sintered to achieve densification and mechanical integrity of the construct.

More specifically, similar to the preparation of an electrolyte slurry, the preparation of an anode support slurry follows a similar process. The preparation of the anode support material slurry includes mixing a dispersant in a solvent of xylene and ethanol and subjecting the mixture to RAM for 3 minutes at an acceleration intensity of 80 G. Simultaneously, the anode support particulates of NiO and 3YSZ are mixed in a solvent using RAM for 5 minutes at 80 G. The two mixture are combined and subjected to RAM for 8 minutes at 80 G. A pore former can be optionally added at this time or later, followed by subjecting the mixture to RAM for 5 minutes at 80 G. A plasticizer can be added with the resulting mixture subjected to RAM for 3 minutes at 80 G. A binder can be added with the resulting mixture subjected to RAM for 5 minutes at 80 G. The anode slurry is then defoamed and/or de-aerated using RAM for 1 minute at 20 G. The anode support slurry is then ready for casting into an independent anode support shape, or casting on the electrolyte layer formed as described above.

With the construct of a three-layered anode supported anode-electrolyte structure completed, the three layer tape casting can be rolled or folded and stored in plastic for subsequent treatment and handling. An embodiment of NiO+3YSZ/NiO+8YSZ/8YSZ 3-in-1 green tape was made in accordance with the present teachings.

We then move to flow line 18 in FIG. 1B and follow it from right to left. More specifically, subsequent to formation of the 3-in-1 green tape, the structure typically is sintered, which burns out the fugitive plasticizer(s) and fugitive binder(s). Often the three-layered anode supported anode-electrolyte structure is subjected to degreasing, then sintering to form a sintered three-layered anode supported anode-electrolyte structure.

Returning to FIG. 1B, along flow line 18 from right to left, in some embodiments, a barrier layer can be applied to the sintered electrolyte (e.g., YSZ) layer of the three-layered structure. A barrier layer slurry can be printed onto the sintered electrolyte layer. The barrier layer slurry can be prepared by mixing dispersant in a solvent such as terpineol using RAM for 3 minutes at 80 G. The barrier layer particulates can be added to the dispersant mixture, then subjected to RAM for 15 minutes at 80 G. A binder next can be added with the resulting mixture subjected to RAM for 10 minutes at 80 G, which completes the formation of the barrier layer slurry. The barrier layer slurry is ready for casting and/or printing. Subsequent to application of a barrier layer slurry to the forming SOC, the four-layered structure can be subjected to sintering.

In certain embodiments, a cathode layer can be subsequently applied to the barrier layer to complete a SOC. In particular embodiments, the cathode layer is created similar to the anode and electrolyte layers by creating a cathode layer slurry using RAM to mix and de-gas slurry. Similar to the barrier layer, in some embodiments, the cathode layer slurry is printed onto the barrier layer or the electrolyte layer, depending on the design of the SOC. The cathode layer slurry can be prepared by mixing dispersant in a solvent such as terpineol using RAM for 3 minutes at 80 G. The cathode layer particulates can be added to the dispersant mixture, then subjected to RAM for 15 minutes at 80 G. A binder next can be added with the resulting mixture subjected to RAM for 10 minutes at 80 G, which completes the formation of the cathode layer slurry. The cathode layer slurry is ready for casting and/or printing. Subsequent to application of a cathode layer slurry to the forming SOC, the completed SOC structure can be subjected to sintering.

Having disclosed aspects of a solid oxide cell (SOC), some additional features are now introduced.

Quantitative Microstructure. In one embodiment, a ceramic electrolyte powder exhibits a primary particle size distribution with a mean particle size between 80 nanometers and 250 nanometers. A sintered electrolyte layer makes use of the powder and establishes a grain size distribution with a mean grain size between 1 micrometer and 3 micrometers. A ratio between the mean grain size of the sintered electrolyte layer and the mean particle size of the ceramic electrolyte powder remains between 4 and 37.5. This relationship establishes retention of particulate integrity during thermal processing. The sintered electrolyte layer establishes a porosity level less than 0.5 percent by volume. A porosity measurement uses cross-sectional image analysis to confirm the absence of interconnected pore pathways across the thickness of the layer. The dense ceramic structure establishes reliable separation between an anode layer and a cathode layer.

Comparative Example A—RAM Mixed Slurry vs Ball-Milled Slurry. In one embodiment, a first electrolyte slurry forms through acoustic-energy mixing of a solvent phase, a dispersant phase, a ceramic particulate phase, a binder phase, and a plasticizer phase. A second electrolyte slurry forms through a ball-mill mixer that blends the same phases. A first sintered electrolyte layer forms from the slurry mixed by acoustic energy. A second sintered electrolyte layer forms from the slurry mixed by the ball-mill mixer. A measurement of the first sintered electrolyte layer shows a mean grain size between 1 micrometer and 3 micrometers. A measurement of the second sintered electrolyte layer shows a mean grain size between 4 micrometer and 9 micrometers. A measurement of ohmic area-specific resistance for the first electrolyte layer at 800 degrees Celsius yields a value less than 0.03 ohm-centimeter squared. A measurement of ohmic area-specific resistance for the second electrolyte layer at 800 degrees Celsius yields a value greater than 0.05 ohm-centimeter squared. A comparison of these microstructural and electrical results establishes that acoustic-energy mixing supports improved particulate integrity and increased electrolyte density.

Comparative Example B—Three-layer RAM tape vs laminated tape. In one embodiment, a three-layer green structure forms by sequential casting of an anode support slurry, an anode slurry, and an electrolyte slurry. Each slurry undergoes acoustic-energy mixing before casting. A laminated green structure forms by stacking three independently cast tapes and compressing the tapes. A sintered three-layer structure shows continuous contact across the interface between the anode support layer and the anode layer. A sintered laminated structure shows a planar boundary between the same layers. A cross-sectional image of the three-layer structure shows no delamination plane. A cross-sectional image of the laminated structure shows incomplete particulate interpenetration along the lamination boundary. The electrolyte region within the three-layer structure exhibits a thickness between 3 micrometers and 6 micrometers with uniformity across the lateral dimension. The electrolyte region within the laminated structure exhibits a thickness variation greater than 20 percent across its width. These structural comparisons establish that sequential casting supports formation of a fully integrated multilayer ceramic structure.

“Substantially Unchanged Particulates.” In one embodiment, a ceramic electrolyte powder exhibits a particulate morphology defined by angular and equiaxed shapes. A sintered electrolyte layer forms from the ceramic electrolyte powder and exhibits grain boundaries that maintain these angular and equiaxed characteristics. A quantitative evaluation of the ceramic electrolyte powder shows a primary particle size distribution with a defined mean particle size. A corresponding evaluation of the sintered electrolyte layer shows a grain size distribution with a mean grain size that changes by less than 30 percent relative to the primary particle size. A comparison of aspect ratio distributions before sintering and after sintering shows a change less than 10 percent. This set of structural measurements supports the conclusion that the electrolyte layer forms without substantial alteration of particulate geometry.

System-Level Embodiment. In one embodiment, a reversible solid-oxide apparatus includes a stack of solid oxide cells, a gas-distribution assembly, a storage vessel, and an electrical circuit. The stack includes a plurality of solid oxide cells that each include an anode support layer, an anode layer, an electrolyte layer, and a cathode layer. Each electrolyte layer defines a dense ceramic structure with a thickness between 3 micrometers and 6 micrometers. The gas-distribution assembly directs a hydrogen-containing stream toward an anode side of the stack during fuel-cell operation. The gas-distribution assembly directs a steam-containing stream toward a cathode side of the stack during electrolyzer operation. The storage vessel retains a chemical product generated during electrolyzer operation. The electrical circuit supplies electrical energy to the stack during electrolyzer operation and receives electrical energy from the stack during fuel-cell operation. A coordinated control of the gas-distribution assembly, the storage vessel, and the electrical circuit establishes a reversible energy-storage function within the apparatus.

As to electrical properties, the solid oxide cell according to the teachings herein exhibits electrical characteristics that arise from the structure of the electrolyte layer and the adjacent electrode layers. The cell establishes an open-circuit voltage within a range associated with high-temperature electrochemical conversion under a hydrogen fuel stream and an air oxidant stream. The current-voltage behavior reflects a low area-specific resistance that includes an ohmic component and a polarization component. The ohmic component reflects resistance within the electrolyte, the anode, the cathode, and any electrical contacts. The polarization component reflects charge-transfer processes and gas-transport processes within the porous electrodes.

Electrochemical impedance spectroscopy identifies an ohmic resistance of about 0.03 ohm-cm² under test conditions between 600° C. and 800° C. The high-frequency intercept of the impedance plot defines this ohmic value. The difference between the high-frequency intercept and the low-frequency intercept defines the polarization resistance. The polarization resistance varies with temperature, gas composition, and current density. The combined resistance supports current densities within a multi-ampere-per-square-centimeter range at practical operating voltages.

The power density increases with temperature and reaches values within a watt-per-square-centimeter range at 600° C. to 800° C. The measured current-voltage-power curves identify a maximum power density of about 5 W/cm² at a cell voltage of about 0.75 V at 800° C. The cell maintains stable electrical performance during extended operation. A long-term test at 750° C. under constant current shows a voltage degradation rate of less than 0.058 mV/h over 253 h. A thermal-cycling test between 400° C. and 750° C. shows no substantial loss of electrical output over a period of about 400 h.

The electrical behavior allows incorporation of the solid oxide cell into energy-conversion and energy-storage apparatuses that require low internal resistance, stable performance, and compatibility with reversible operation. The structure supports fuel-cell operation that generates electrical energy and electrolyzer operation that stores electrical energy in chemical form.

Another apparatus can include a solid oxide electrolyzer configured to convert electrical energy into chemical energy by producing hydrogen, syngas, oxygen, or ammonia precursors. The ultra-thin electrolyte enables reduced ohmic losses, which increases the efficiency of high-temperature electrolysis when paired with renewable or off-peak electrical sources.

A further apparatus can incorporate the SOC stack into a reversible solid-oxide energy-storage module. In this example, the stack operates as an electrolyzer during periods of excess electrical supply and as a fuel cell during periods of electrical demand. The combined system can store energy chemically in the form of hydrogen, carbon monoxide, methane, or other reduced products generated during electrolysis. The stored chemical stream can be reconverted to electrical energy through fuel-cell mode operation. Such a module can be used in support of grid-balancing services, long-duration storage installations, or hybrid renewable-energy systems.

A compact SOC assembly can also be integrated into portable power units, industrial backup power systems, or remote instrumentation packages where the rapid manufacturing approach reduces cost and increases reliability. The thin-film electrolyte structures described herein provide for high power density in a small footprint, enabling deployment in environments with weight or volume constraints.

To facilitate an understanding of the present invention, a number of terms and phrases are defined below.

Unless defined otherwise, all technical and scientific terms used herein have the same meaning as commonly understood by one of ordinary skill in the art to which this invention belongs. The abbreviations used herein have their conventional meaning within the chemical and biological arts. The chemical structures and formulae set forth herein are constructed according to the standard rules of chemical valency known in the chemical arts.

The terms “a” and “an” as used herein mean “one or more” and include the plural unless the context is inappropriate.

In the application, where an element or component is said to be included in and/or selected from a list of recited elements or components, it should be understood that the element or component can be any one of the recited elements or components, or the element or component can be selected from a group consisting of two or more of the recited elements or components.

Further, it should be understood that elements and/or features of a composition or a method described herein can be combined in a variety of ways without departing from the spirit and scope of the present invention, whether explicit or implicit herein. For example, where reference is made to a particular compound, that compound can be used in various embodiments of compositions of the present invention and/or in methods of the present invention, unless otherwise understood from the context. In other words, within this application, embodiments have been described and depicted in a way that enables a clear and concise application to be written and drawn, but it is intended and will be appreciated that embodiments can be variously combined or separated without parting from the present teachings and invention(s). For example, it will be appreciated that all features described and depicted herein can be applicable to all aspects of the invention(s) described and depicted herein.

In other words, all statements herein reciting principles, aspects, and embodiments of the disclosure, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

In the disclosure herein of any element expressed as a means for performing a specified function is intended to encompass any way of performing that function including, for example, a) a combination of circuit elements and associated hardware which perform that function or b) software in any form, including, therefore, firmware, microcode or the like as set forth herein, combined with appropriate circuitry for executing that software to perform the function. Accordingly, any means which can provide those functionalities can be regarded as equivalent to those shown herein. No functional language used in claims appended herein is to be construed as invoking 35 U.S.C. § 112(f) interpretations as “means-plus-function” language unless specifically expressed as such by use of the words “means for” or “steps for” within the respective claim.

It should be understood that the expression “at least one of” includes individually each of the recited objects after the expression and the various combinations of two or more of the recited objects unless otherwise understood from the context and use. The expression “and/or” in connection with three or more recited objects should be understood to have the same meaning unless otherwise understood from the context.

The use of the term “include,” “includes,” “including,” “have,” “has,” “having,” “contain,” “contains,” or “containing,” including grammatical equivalents thereof, should be understood generally as open-ended and non-limiting, for example, not excluding additional unrecited elements or steps, unless otherwise specifically stated or understood from the context.

Where the use of the term “about” is before a quantitative value, the present invention also includes the specific quantitative value itself, unless specifically stated otherwise. As used herein, the term “about” refers to a ±10% variation, a ±5% variation, or a ±2.5% variation from the nominal value as understood from the context, unless otherwise indicated or inferred from the context.

At various places in the present specification, values are disclosed in groups or in ranges. It is specifically intended that the description include each and every individual sub-combination of the members of such groups and ranges. For example, an integer in the range of 0 to 40 is specifically intended to individually disclose 0, 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31 32, 33, 34, 35, 36, 37, 38, 39, and 40, and an integer in the range of 1 to 20 is specifically intended to individually disclose 1, 2, 3, 4, 5, 6, 7, 8, 9, 10, 11, 12, 13, 14, 15, 16, 17, 18, 19, and 20.

The use of any and all examples, or exemplary language herein, for example, “such as” or “including,” is intended merely to illustrate better the present invention and does not pose a limitation on the scope of the invention unless claimed. The examples provided herein are intended solely for illustrative purposes and are not to be interpreted as restricting the disclosed subject matter to the specific embodiments presented. No language in the specification should be construed as indicating any non-claimed element as essential to the practice of the present invention.

Throughout the description, where compositions and kits are described as having, including, or comprising specific components, or where processes and methods are described as having, including, or comprising specific steps, it is contemplated that, additionally, there are compositions and kits of the present invention that consist essentially of, or consist of, the recited components, and that there are processes and methods according to the present invention that consist essentially of, or consist of, the recited processing steps.

As a general matter, compositions specifying a percentage are by weight unless otherwise specified.

Any particular embodiment of the present teachings that falls within the prior art can be explicitly excluded from any one or more of the claims. Because such embodiments are deemed to be known to one of ordinary skill in the art, they can be excluded even if the exclusion is not set forth explicitly herein. Any particular embodiment of the disclosure can be excluded from any claim, for any reason, whether or not related to the existence of prior art.

The disclosure can be embodied in other specific forms without departing from the spirit or essential characteristics thereof. The foregoing embodiments are therefore to be considered in all respects illustrative rather than limiting the disclosure described herein. Scope of the disclosure is thus indicated by the appended claims rather than by the foregoing description, and all changes that come within the meaning and range of equivalency of the claims are intended to be embraced therein.

What is claimed is:

1. An electrolyte layer comprising:
a sintered ceramic material, wherein the electrolyte layer establishes a mean grain size between 1 micrometer and 3 micrometers, wherein a ceramic powder used to form the electrolyte layer establishes a mean particle size between 80 nanometers and 250 nanometers,
wherein a ratio of the mean grain size to the mean particle size remains between 4 and 37.5, and wherein the electrolyte layer has a thickness between 1 micrometers and 25 micrometers.

2. The electrolyte layer of claim 1, wherein the electrolyte layer establishes a porosity less than 0.5 percent by volume.

3. The electrolyte layer of claim 1, wherein the sintered ceramic material comprises a solid solution that includes at least one oxide selected from zirconium oxide, yttrium oxide, scandium oxide, hafnium oxide, cerium oxide, and gadolinium oxide.

4. The electrolyte layer of claim 1, wherein the electrolyte layer comprises yttria-stabilized zirconia.

5. The electrolyte layer of claim 1, wherein the electrolyte layer comprises a ceria-based ceramic selected from gadolinium-doped ceria and samarium-doped ceria.

6. The electrolyte layer of claim 1, wherein the electrolyte layer exhibits no interconnected pore network across its thickness.

7. The electrolyte layer of claim 1, wherein the electrolyte layer exhibits a grain morphology that matches an angular or equiaxed particulate morphology of the ceramic powder.

8. The electrolyte layer of claim 1, wherein the electrolyte layer defines an ohmic area-specific resistance less than 0.03 ohm-centimeter squared at a temperature between 700 degrees Celsius and 800 degrees Celsius.

9. The electrolyte layer of claim 1, wherein the electrolyte layer forms a portion of a three-layer structure that includes an anode layer and an anode support layer disposed on a first side of the electrolyte layer.

10. The electrolyte layer of claim 9, wherein the three-layer structure establishes continuous particulate contact across an interface between the anode layer and the anode support layer.

11. The electrolyte layer of claim 9, wherein the three-layer structure exhibits no lamination boundary between the anode layer and the anode support layer.

12. A solid oxide cell comprising an electrolyte layer comprising:
a sintered ceramic material, wherein the electrolyte layer establishes a mean grain size between 1 micrometer and 3 micrometers, wherein a ceramic powder used to form the electrolyte layer establishes a mean particle size between 80 nanometers and 250 nanometers,
wherein a ratio of the mean grain size to the mean particle size remains between 4 and 37.5, and wherein the electrolyte layer has a thickness between 1 micrometers and 25 micrometers,
an anode layer disposed on a first surface of the electrolyte layer, and a cathode layer disposed on a second surface of the electrolyte layer.

13. The solid oxide cell of claim 12, further comprising an anode support layer disposed on the anode layer.

14. The solid oxide cell of claim 12, wherein the anode layer comprises nickel oxide and a ceramic oxide that matches the composition of the electrolyte layer.

15. The solid oxide cell of claim 12, wherein the electrolyte layer, the anode layer, and the anode support layer are prepared by a layer-by-layer method.

16. The solid oxide cell of claim 12, wherein the cathode layer comprises a perovskite-type oxide selected from lanthanum strontium manganite, lanthanum strontium cobalt ferrite, and barium strontium cobalt ferrite.

17. The solid oxide cell of claim 12, further comprising a barrier layer disposed between the electrolyte layer and the cathode layer.

18. The solid oxide cell of claim 12, wherein the electrolyte layer establishes a mean grain size within ±30 percent of the mean particle size of the ceramic powder used to form the electrolyte layer.

19. The solid oxide cell of claim 12, wherein the electrolyte layer exhibits a grain morphology that matches a particulate morphology of the ceramic powder.

20. An apparatus comprising a plurality of solid oxide cells comprising an electrolyte layer comprising:
a sintered ceramic material, wherein the electrolyte layer establishes a mean grain size between 1 micrometer and 3 micrometers, wherein a ceramic powder used to form the electrolyte layer establishes a mean particle size between 80 nanometers and 250 nanometers,
wherein a ratio of the mean grain size to the mean particle size remains between 4 and 37.5, and wherein the electrolyte layer has a thickness between 1 micrometers and 25 micrometers,
an anode layer disposed on a first surface of the electrolyte layer, and a cathode layer disposed on a second surface of the electrolyte layer; and
an electrical circuit configured to receive electrical energy from the plurality of solid oxide cells or supply electrical energy to the plurality of solid oxide cells.

21. The apparatus of claim 20, wherein the apparatus operates as a reversible energy-storage system that supplies electrical energy during fuel-cell operation and stores electrical energy in chemical form during electrolyzer operation.
